(19) United States
(12) Patent Application Publication
(10) Pub. No.: US 2025/0071705 A1
(43) Pub. Date: Feb. 27, 2025

(54) Clock Synchronization and Latency Reduction in an Audio WMAS

(71) Applicant: WAVES AUDIO LTD., Tel Aviv (IL)

(72) Inventors: Dan Wolberg, Moshav Yanuv (IL); Nir Tal, Haifa (IL); Gadi Sharazi, Ramat Gan (IL)

(21) Appl. No.: 18/843,324

(22) PCT Filed: Mar. 8, 2024
(86) PCT No.: PCT/IL2023/050242

§ 371 Date: Sep. 3, 2024

(30) Foreign Application Priority Data
Mar. 9, 2022 (GB) 220325.3
Mar. 9, 2022 (GB) 2203234.6

(51) Int. Cl. H04W 56/00; H04R 3/00; H04R 27/00

(52) U.S. Cl. CPC H04W 56/0015; H04R 3/005; H04R 27/00; H04R 2420/07

(57) ABSTRACT

System-wide clock synchronization and latency reduction of audio signals in a wireless multi-channel audio system (WMAS). The apparatus includes: a base station and a wireless audio device. The base station includes: a master clock source; a framer operative to generate base station frames containing audio data and related audio clock timing derived from said master clock source; and a transmitter operative to transmit the frames over the WMAS. The wireless audio device includes: a receiver operative to receive frames from the base station over the WMAS; and a clock generator circuit operative to input a local clock signal generated by a frame synchronization circuit to generate therefrom multiple clocks derived from the timing signal to synchronize the wireless audio device to base station frames and to enable thereby communications according to a previously determined schedule with the base station.

### FIELD OF THE DISCLOSURE

The subject matter disclosed herein relates to the field of communications and more particularly relates to systems and methods of clock synchronization and latency reduction in a multidevice bidirectional communication system such as a Wireless Multichannel Audio System (WMAS) also referred to as a wireless venue area network (WVAN).

### BACKGROUND OF THE INVENTION

Wireless audio (and video) (A/V) equipment used for real-time production of audio-visual information such as for entertainment or live events and conferences are denoted by the term program making and special events (PMSE). Typically, the wireless A/V production equipment includes cameras, microphones, in-car monitors (IEMs), conference systems, and mixing consoles. PMSE use cases can be diverse, while each commonly being used for a limited duration in a confined local geographical area. Typical live audio/video production setups require very low latency and very reliable transmissions to avoid failures and perceptible corruption of the media content.

Accurate synchronization is also important to minimize jitter among captured samples by multiple devices to properly render audio video content. For example, consider a live audio performance where the microphone signal is streamed over a wireless channel to an audio mixing console where different incoming audio streams are mixed. In-car audio mixes are streamed back to the microphone users via the wireless IEM system. To achieve this, the audio sampling of microphones' signals should be synchronized to the system clock, which is usually integrated into the mixing console used for capturing, mixing, and playback of the audio signals.

Wireless microphones are in common use today in a variety of applications including large venue concerts and other events where use of wired microphones is not practical or preferred. A wireless microphone has a small, battery-powered radio transmitter in the microphone body, which transmits the audio signal from the microphone by radio waves to a nearby receiver unit, which recovers the audio. The other audio equipment is connected to the receiver unit by cable. Wireless microphones are widely used in the entertainment industry, television broadcasting, and public speaking to allow public speakers, interviewers, performers, and entertainers to move about freely while using a microphone without requiring a cable attached to the microphone.

Wireless microphones usually use the VHF or UHF frequency bands since they allow the transmitter to use a small unobtrusive antenna. Inexpensive units use a fixed frequency but most units allow a choice of several frequency channels, in case of interference on a channel or to allow the use of multiple microphones at the same time. FM modulation is usually used, although some models use digital modulation to prevent unauthorized reception by scanner radio receivers; these operate in the 900 MHZ, 2.4 GHz or 6 GHZ ISM bands. Some models use antenna diversity (i.e. two antennas) to prevent nulls from interrupting transmission as the performer moves around.

Most analog wireless microphone systems use wideband FM modulation, requiring approximately 200 kHz of bandwidth. Because of the relatively large bandwidth requirements, wireless microphone use is effectively restricted to VHF and above. Older wireless microphone systems operate in the VHF part of the electromagnetic spectrum.

Most modern wireless microphone products operate in the UHF television band. In the United States, this band extends from 470 MHz to 614 MHz. Typically, wireless microphones operate on unused TV channels (‘white spaces’), with room for one to two microphones per megahertz of spectrum available.

Pure digital wireless microphone systems are also in use that use a variety of digital modulation schemes. Some use the same UHF frequencies used by analog FM systems for transmission of a digital signal at a fixed bit rate. These systems encode an RF carrier with one channel, or in some cases two channels, of digital audio. Advantages offered by purely digital systems include low noise, low distortion, the opportunity for encryption, and enhanced transmission reliability.

Some digital systems use frequency hopping spread spectrum technology, similar to that used for cordless phones and radio-controlled models. As this can require more bandwidth than a wideband FM signal, these microphones typically operate in the unlicensed 900 MHZ, 2.4 GHz or 6 GHz bands.

Several disadvantages of wireless microphones include (1) limited range (a wired balanced XLR microphone can run up to 300 ft or 100 meters); (2) possible interference from other radio equipment or other radio microphones; (3) operation time is limited relative to battery life; it is shorter than a normal condenser microphone due to greater drain on batteries from transmitting circuitry; (4) noise or dead spots, especially in non-diversity systems; (5) limited number of operating microphones at the same time and place, due to the limited number of radio channels (i.e. frequencies); (6) lower sound quality.

Another important factor with the use of wireless microphones is latency which is the amount of time it takes for the audio signal to travel from input (i.e. microphone) to audio output (i.e. receiver or mixing console). In the case of analogue wireless systems, the microphone converts the acoustical energy of the sound source into an electrical signal, which is then transmitted over radio waves. Both the electrical and RF signal travel at the speed of light making the latency of analogue wireless systems negligible.

In the case of digital wireless systems, the acoustic to electrical transformation remains the same, however, the electrical audio signal is converted into a digital bit stream. This conversion from analog audio to digital takes time thus introducing latency into the system. The amount of latency in a digital wireless system depends on the amount of signal processing involved, and also the RF mechanisms employed.

For typical performers in a live performance using stage monitors, 5 to 10 milliseconds of latency are acceptable. Beyond 10 milliseconds, signal delay becomes noticeable, which may have a detrimental effect on performers' timing and overall delivery. Latency is especially critical for certain performances such as vocalists and drummers, for example, during live applications that utilize in-ear monitor systems. This is because performers hear their performance both from the monitoring system and through vibrations in their bones. In such scenarios, round trip latency should be no more than 6 milliseconds to avoid compromising performance.

### SUMMARY OF THE INVENTION

This disclosure describes a system and method of clock synchronization and latency reduction in a multidevice bidirectional communication system such as an audio wireless venue area network (WVAN) also referred to as a wireless multichannel audio system (WMAS). The WMAS of the invention includes a base station and wireless audio devices such as microphones, in-ear monitors, etc. that can be used for live events, concerts, nightclubs, churches, etc. The WMAS is a multichannel digital wideband system as opposed to most commercially available narrowband, e.g. GFSK, and analog prior art wireless microphone systems. The system may be designed to provide an extremely low latency of less than 6 milliseconds for the round-trip audio delay from the microphone to the mixing console and back to an in-car monitor, for example.

Low latency may be achieved by synchronization of the entire system including the codec, transmit and receive frames, local clocks, messages, and frame synchronization. In one embodiment, the entire OSI stack is synchronous. The system may use a single master clock in the base station from which all other clocks both in the base station and devices are locked and derived from.

In addition, the size of the TX packet buffer in both the devices and base station may be an integral number of the size of the audio compressor buffer in the transmitter and in the receiver the RX packet buffer may be an integral multiple of the size of the audio expander buffer. This enables the elimination of the audio compressor output buffer (and the audio expander input buffer) where compressed packets are directly written from the compressor to the TX packet buffer (and from the RX packet buffer directly to the expander). The elimination of the audio compressor output buffer (and the audio expander input buffer) significantly reduces the overall latency of the audio. System wide synchronization enables the elimination of the audio compressor output buffer and the audio expander input buffer.

There is thus provided in accordance with embodiments of the present system-wide clock synchronization and latency reduction of audio signals for use in a wireless multi-channel audio system (WMAS). The WMAS includes: a base station and a wireless audio device. The base station includes: a master clock source; a framer operative to generate base station frames containing audio data and related audio clock timing derived from said master clock source; and a transmitter operative to transmit the frames over the WMAS. The wireless audio device includes: a receiver operative to receive frames from the base station over the WMAS; a frame synchronization circuit operative to generate audio data and a related timing signal from the received frames; and a clock generator circuit operative to input a local clock signal generated by said frame synchronization circuit to generate therefrom multiple clocks, including an audio clock, derived from the timing signal to synchronize the wireless audio device to base station frames and to enable thereby communications according to a previously determined schedule with the base station. The previously determined schedule may include uplink and downlink communications over a same channel.

In the wireless audio device, the frame synchronization circuit may be operative to generate audio data and related timing using detected PHY frame boundary timing via signal correlation associated with the received frames.

The wireless audio device may be included in a microphone system. The wireless audio device may further include: an analog-to-digital converter (ADC) for converting an input audio signal to digital domain utilizing the audio clock generated by the clock generator circuit; a synchronization buffer operative to receive digital output of the ADC; a compressor and related compressor buffer operative to receive output of the synchronization buffer; a first RF modem including a transmitter and related TX packet buffer operative to receive output of the compressor. Compressed packets may be directly written from the compressor buffer to a TX packet buffer for transmission to the base station. The TX packet buffer size may be an integral number of the size of the compressor buffer.

The wireless audio device may be included in an in-ear monitor. The wireless audio device may further include: an expander and related expander buffer; an RF modem and related RX packet buffer operative to output compressed packets directly written from the RX packet buffer to the expander buffer; and a digital-to-analog (DAC) converter operative to input audio samples from the expander buffer to output an analog audio signal, utilizing the audio clock. The RX packet buffer size may be an integral number of the expander buffer size.

The master clock source may include a local oscillator in the base station or a clock signal from an audio mixing console to a digital interface in the base station.

During operation: (i) clocks in the WMAS synchronized to and derived from the master clock source in the base station; and (ii) the communications with the previously determined schedule, enable a reduction of latency to less than or equal to four milliseconds and in some embodiments less than three milliseconds. The latency is a time interval between reception of an audio event at a microphone and outputting an audio signal from the base station corresponding to the audio event. The wireless audio device may include a synchronization circuit operative to provide digital feedforward synchronization of an audio clock to frame synchronization clock timing; or to provide analog feedback synchronization of an audio clock to frame synchronization clock timing.

The multiple clocks derived from the clock generator circuit may include: an analog-to digital converter (ADC) clock, a digital-to-analog converter (DAC) clock, a transmitter (TX) clock, a receiver (RX) clock, and/or a radio frequency (RF) clock.

The frame synchronization circuit may include at least one of: a packet detector circuit, a correlator circuit, a phase locked loop (PLL) circuit, a delay locked loop (DLL) circuit, and a frequency locked loop (FLL) circuit.

In accordance with embodiments of the present invention, various methods are provided for system-wide clock synchronization of audio signals for use in a wireless multi-channel audio system (WMAS) including a base station and a wireless audio device. In the base station, a master clock source is provided, and first clocks are generated including a first audio clock synchronized to the master clock source. Frames are generated containing audio data and timing is derived from the master clock. The frames are transmitted over the WMAS.

In the wireless audio device, the frames are received from the base station over the WMAS, and clock timing is generated from the received frames. Second clocks are generated including a second audio clock synchronized to the clock timing.

The first clocks in the base station and the second audio clock in the wireless audio device are synchronized to the master clock source to enable communications according to a previously determined schedule with the base station. The second clocks may include at least one of an audio clock, ADC clock, DAC clock, TX clock, RX clock, and/or RF clock

In the wireless audio device: audio data may be generated, and the related clock timing may be detected using PHY frame boundary timing via signal correlation associated with the received frames. The previously determined schedule may include uplink and downlink communications over a same frequency channel.

Synchronization of the communications with the previously determined schedule enables a reduction of latency, to less than or equal to four nanoseconds and in some embodiments less than three nanoseconds. The latency is a time interval between reception of an audio event at a microphone and outputting an audio signal from the base station corresponding to the audio event. In the wireless audio device, an audio clock may be synchronized to the frame synchronization clock timing using digital feedforward synchronization or using analog feedback synchronization.

Clock timing from the received frames may be performed using a packet detector circuit, correlator circuit, phase locked loop (PLL) circuit, delay locked loop (DLL) circuit, and/or frequency locked loop (FLL) circuit.

According to various embodiments of the present invention, a wireless audio device for use in a multichannel audio system (WMAS) may be included in a microphone system or in an in-car monitor. The wireless audio device may include: a receiver operative to receive frames over said WMAS, the frames containing timing derived from a master clock source in said WMAS; a frame synchronization circuit operative to extract clock timing from said received frames; and a clock generator circuit operative to generate multiple clocks synchronized to the clock timing generated by the frame synchronization circuit to synchronize the wireless audio device to the received frames and to enable thereby communications according to a previously determined schedule.

The frame synchronization circuit may be operative to generate audio data and related timing using detected PHY frame boundary timing via signal correlation associated with the received frames. The previously determined schedule may include uplink and downlink communications over a same frequency channel. During operation (i) the clock synchronized to and derived from said master clock source, and (ii) the communications according to the previously determined schedule, enable a reduction of latency, to less than or equal to four nanoseconds, and in some embodiments less than three milliseconds. The latency is a time interval between reception of an audio event at a microphone and outputting an audio signal from the base station corresponding to the audio event.

Various methods and systems are provided herein for minimizing latency in a wireless multichannel audio system (WMAS), including a base station and multiple wireless audio devices. In the wireless audio devices, an audio clock is synchronized to a single master clock in the base station. An analog to digital converter (ADC) is operative to convert an input audio signal to digital domain utilizing the audio clock. A synchronization buffer is operative to receive digital output from the ADC. A compressor and related compressor buffer is operative to receive output of the synchronization buffer. A first RF modem including a transmitter and related TX packet buffer is operative to receive output of the compressor. The TX packet buffer size is an integer multiple of the output of said compressor. The base station includes: the single master clock; a second audio clock synchronized to the single master clock; a second RF modem including a receiver and related RX packet buffer; and an expander and related expander output buffer operative to receive output of said RX packet buffer. The RX packet buffer size is an integer multiple of the input to the expander.

Various methods and systems are provided herein for minimizing latency in a wireless multichannel audio system (WMAS), including a base station. In the base station, an audio clock is synchronized to a single master clock. An ADC is operative to convert an input audio signal to digital domain utilizing the audio clock. A synchronization buffer is operative to receive digital output of the ADC. A compressor and related compressor buffer are operative to receive output of the synchronization buffer and an RF modem including a transmitter and related TX packet buffer is operative to receive block output of the compressor. The TX packet buffer size is an integer multiple of the block output of said compressor.

Various methods and systems are provided herein for minimizing latency in a wireless multichannel audio system (WMAS), including a base station. In the base station, an audio clock is synchronized to a single master clock. An RF modem including a receiver and related RX packet buffer is operative to receive packets over the WMAS and store them in the RX packet buffer. An expander and related expander output buffer is operative to receive block output of the RX packet buffer. The RX packet buffer size is an integer multiple of the block input to the expander.

There is also provided in accordance with the invention, an apparatus for minimizing latency for use in a device in a wireless multichannel audio system (WMAS) including a wireless device and a base station. The wireless device includes: an audio clock synchronized to a single master clock in the base station; an analog-to digital converter (ADC) for converting an input audio signal to digital domain utilizing the audio clock; a synchronization buffer operative to receive digital output of the ADC, a compressor and related compressor buffer operative to receive output of said synchronization buffer, and an RF modem including a transmitter and related TX packet buffer operative to receive block output of the compressor. The TX packet buffer size is an integer multiple of the block output of the compressor.

There is further provided in accordance with the invention, an apparatus for minimizing latency for use in a base station in a wireless multichannel audio system (WMAS). The base station includes an audio clock synchronized to a single master clock, an RF modem including a receiver and related RX packet buffer operative to receive packets over said WMAS and store them in said RX packet buffer, and an expander and related expander output buffer operative to receive block output of the RX packet buffer. The RX packet buffer size is an integer multiple of the block input to the expander.

An uplink apparatus for system-wide clock synchronization of audio signals for use in a wireless multi-channel audio system (WMAS). The uplink apparatus includes a base station and a wireless audio device, e.g. microphone. The base station includes: a master clock source, a framer operative to generate frames containing audio data and related audio clock timing derived from the master clock source; and a transmitter operative to transmit frames over the WMAS. The wireless audio device includes a receiver operative to receive frames from the base station over the WMAS; a frame synchronization circuit operative to generate audio data and a related timing signal from the received frames; a clock generator circuit operative to input a local clock signal from the timing signal generated by the frame synchronization circuit to generate therefrom an audio clock and a PHY clock both derived from the timing signal; an analog-to-digital converter (ADC) for converting an input audio signal to digital domain utilizing the audio clock; a synchronization buffer operative to receive digital output of the ADC; a compressor and related compressor buffer operative to receive output of the synchronization buffer; a first RF modem including a transmitter and related TX packet buffer operative to receive output of the compressor utilizing the PHY clock. The compressed packets are directly written from the compressor buffer to a TX packet buffer for transmission to the base station.

A downlink apparatus for system wide clock synchronization of audio signals for use in a wireless multi-channel audio system (WMAS) including a base station and an in-ear monitor. The base station includes: a master clock source, a framer operative to generate frames containing audio data and related audio clock timing derived from the master clock source; and a transmitter operative to transmit said frames over the WMAS. The in-ear monitor includes a wireless audio device including: a receiver operative to receive frames from the base station over the WMAS; a frame synchronization circuit operative to receive RF modulated audio data and a related timing signal from the received frames; a clock generator circuit operative to input a local clock signal from the timing signal generated by the frame synchronization circuit to generate therefrom an audio clock and a PHY clock both derived from the timing signal; an expander and related expander buffer; an RF modem and related RX packet buffer operative, utilizing the PHY clock, to output compressed packets directly written from the RX packet buffer to the expander buffer; and a digital-to-analog DAC converter operative to input audio samples from the expander buffer to output an analog audio signal, utilizing the audio clock.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

The present invention is explained in further detail in the following exemplary embodiments and with reference to the figures, where identical or similar elements may be partly indicated by the same or similar reference numerals, and the features of various exemplary embodiments being combinable. The invention is herein described, by way of example only, with reference to the accompanying drawings, wherein:

FIG. 1 is a diagram illustrating an example wireless multichannel audio system (WMAS) incorporating the system and method of clock synchronization and latency reduction of the present invention;

FIG. 2 is a high-level block diagram illustrating an example unidirectional link buffering and clocking scheme;

FIG. 3 is a high level block diagram illustrating an example uplink device and base station scheme;

FIG. 4 is a block diagram illustrating a first example audio synchronization scheme using analog feedback synchronization;

FIG. 5 is a block diagram illustrating a second example audio synchronization scheme using digital feedback synchronization;

FIG. 6 is a high level block diagram illustrating an example downlink device and base station;

FIG. 7 is a diagram illustrating timing for an example WMAS system;

FIG. 8 is a high-level block diagram illustrating an example uplink buffering and clocking scheme;

FIG. 9 is a high level block diagram illustrating an example downlink buffering and clocking scheme;

FIG. 10 is a high-level block diagram illustrating an example frame synchronizer;

FIG. 11 is a flow diagram illustrating am example method of clock synchronization for use in the base station; and

FIG. 12 is a flow diagram illustrating an example method of clock synchronization for use in the wireless audio device.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The invention is operational with numerous general purpose or special purpose computing system environments or configurations. Examples of well-known computing systems, environments, and/or configurations that may be suitable for use with the invention include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

### System Architecture

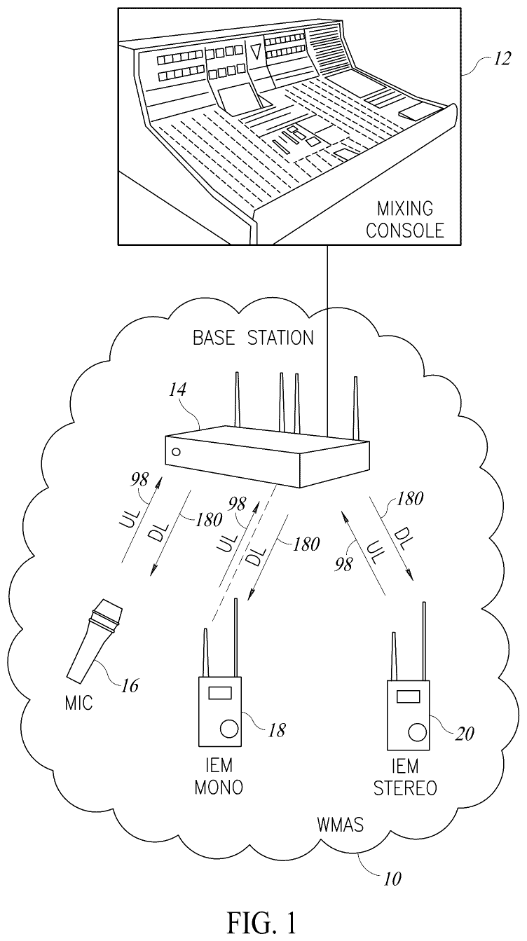

A diagram illustrating an example wireless multichannel audio system (WMAS) incorporating the system and method of clock synchronization of the present invention is shown in FIG. 1. The example WMAS, generally referenced 10, comprises a base station 14 which is typically coupled to a mixing console 12 via one or more cables, and wireless devices including wireless microphones 16, monophonic in-car monitors (IEMs) 18, and stereo IEMs 20 optionally equipped with an inertial measurement unit (IMU).

Wireless microphone devices 16 include an uplink (UL) 98 that transmits audio and management information and a downlink (DL) 180 that receives management information. IEM devices 18 include an uplink 98 that transmits management and a downlink 180 that receives mono audio and management information. IEM devices 20 include an uplink 98 that may transmit IMU and management information and a downlink 180 that may receive stereo audio and management information.

The WMAS comprises a star topology network with a central base station unit (BS) 14 that communicates and controls all the devices within the WMAS (also referred to as “network”). The network is aimed to provide highly reliable communication during a phase of a live event referred to as “ShowTime”. The network at that time is set and secured in a chosen configuration. This minimizes overhead, which is typically present in existing wireless standards, that is needed by the network.

In an embodiment, the features of the WMAS include (1) star topology; (2) point to multipoint audio with predictable schedule including both DL and UL audio on the same channel (typically on a TVB frequency); (3) all devices are time synchronized to base station frames; (4) support for fixed and defined devices; (5) support for frequency division multiplexing (FDM) for extended diversity schemes; (6) TDM network where each device transmits its packet based on an a priori schedule; (7) wideband base station with one or two transceivers receiving and transmitting many (e.g., greater than four) audio channels; (8) TDM/OFDM for audio transmissions and Wideband OFDM (A) in DL and a packet for each device in UL; (10) main and auxiliary wireless channels are supported by all network entities; and (11) all over the air (OTA) audio streams are compressed with ‘zero’ latency.

Regarding latency, the WMAS of the present invention is adapted to provide extremely low latency system (i.e. audio path to audio path) of a maximum of 4 milliseconds including mixing console processing time of 2 milliseconds. An audio event is received by a wireless microphone device. Audio is then wirelessly transmitted over the uplink to the base station (BS). Wired handover to a general purpose audio mixing console occurs with a fixed latency of up to 2 milliseconds, from receiving an audio stream to the return audio stream. The processed audio stream returned to the base station is then wirelessly transmitted over the downlink to an IEM device which plays the audio stream to the user. Uplink latency is defined as an audio event received by a wireless microphone device, then wirelessly transmitted to the base station for output over the audio input/output (IO) and should be no more than 2 milliseconds.

In an embodiment, of the present invention, the WMAS system may achieve performance having: (1) low packet error rate (PER) (e.g., 5e-8) where retransmissions are not applicable; (2) a short time interval of missing audio due to consecutive packet loss and filled by an audio concealment algorithm (e.g., 15 ms); and (3) acceptable range which is supported under realistic scenarios including body shadowing.

In addition, the WMAS system is adapted to operate on the DTV white space UHF channels (i.e. channels 38-51). Note that the system may use a white space channel that is adjacent an extremely high-power DTV station channel while still complying with performance and latency requirements.

It is noted that currently the requirements for a network that ensures low latency across layers for all devices to meet desired performance (i.e. range of 100 m and packet error rate (PER) of 5e-8) are not supported by any standard today. For example, the latency of the Bluetooth (BT) compander by itself is more than the overall required latency (˜6 ms). The inherent buffering of the BT between layers is measured in several milliseconds. Note also that the Wi-Fi 802.11ax standard can support a minimum bandwidth of 20 MHz and a maximum number of eight devices where a narrowband interferer is likely to cause a full loss of connection. Applying the above solutions to the TV frequency band whitespace will fail to comply with most of the attributes outlined supra.

To meet the desired low round trip latency, the system of the present invention utilizes several techniques including (1) all network entities are synchronized to the base station baseband (BB) clock, which is achieved using PHY synchronization signals (time placement calculation) that are locked to the wireless frame time as established by the base station, thus minimizing the buffering to a negligible level; (2) all audio components are synchronized to the baseband clock by a feedback signal from the synchronization buffers; (3) the TX/RX PHY packets contain an integer number of compressed audio buffers; (4) efficient network design; and (5) use of a low latency compander where the delay of the input buffer is the main contributor of latency.

The following definitions apply throughout this document. The latency (expressed as a time interval) of an audio system refers to the time difference from the moment a signal is fed into the system to the moment it appears at the output. Note that any system compression operation applied might be lossy meaning the signal at the output might not be identical to the signal at the input.

Uplink latency is defined as latency (time difference) of the system (i.e. device and the base station) from the moment an audio event appears on the input of the ADC until the event appears on the analog or digital audio output of the base station. Downlink latency is defined as the latency (time difference) of the audio system (device and base station) from the moment an audio event appears on analog or digital input of the base station until it appears on the DAC output of the wireless device. Round trip latency is defined as the latency (time difference) of the audio system from the time an audio event appears on the uplink device input until the time it appears on a downlink device output, while looping back at the base station terminals. Synchronized clocks are defined as clocks that appear to have no long-term drift between them. The clocks may have short term jitter differences but no long-term drift.

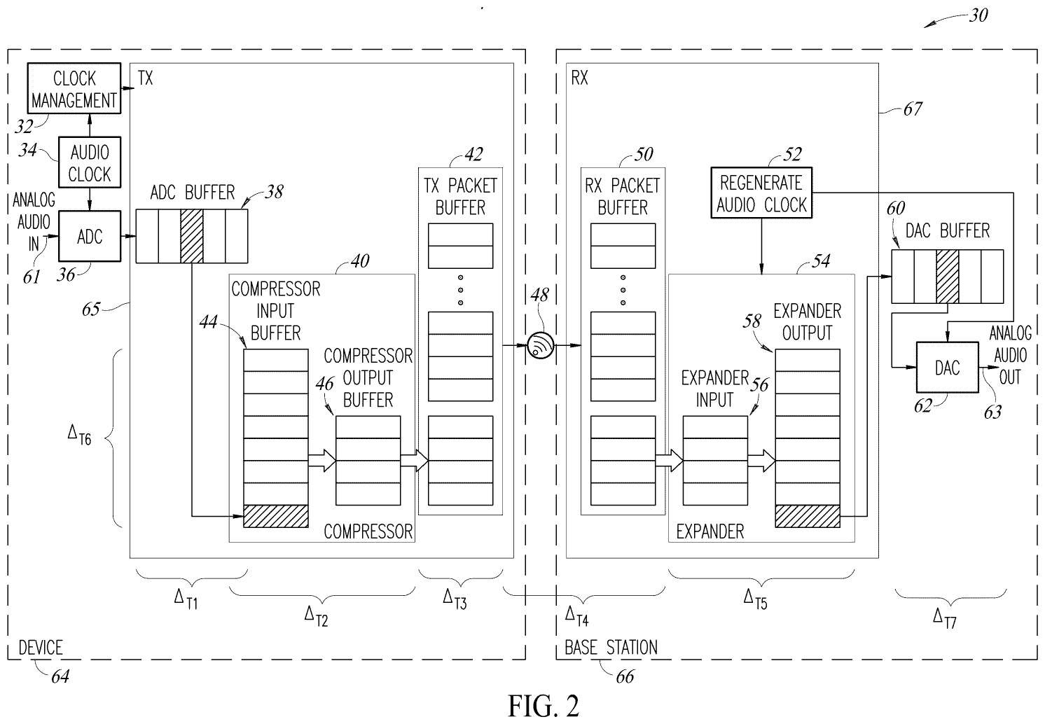

Reference is now made to FIG. 2, which illustrates a high-level block diagram of buffering and clocking in a unidirectional communications link. System 30 includes a centralized base station 66 in communication with one or more devices 64, such as a wireless microphone, over a radio link 48. Base station 66 comprises, inter alia, a receiver (RX) 67, digital-to-analog converter (DAC) buffer 60, and digital-to-analog converter (DAC) 62. RX circuit 67 comprises an RX packet buffer 50 coupled to audio expander 54 and an audio clock regenerator circuit 52. Audio expander 54 comprises audio expander unit 56 and audio expander output 58. Note that multiplexing, combining or mixing of several device audio streams in the base station is typically performed using analog means (not shown).

Device 64 comprises clock management circuit 32, audio clock 34, ADC 36 and TX circuit 65. TX circuit comprises ADC buffer 38, audio compressor circuit 40, and TX packet buffer 42. The audio compressor circuit 40 comprises audio compressor input buffer 44 and audio compressor output buffer 46.

Note that a typical audio compressor 40, (e.g. MP3, AAC, LDAC) of FIG. 2 works in blocks where each input block is compressed into an output block. Similarly, at base station 66, audio expander 54 relies on the current compressed block as well as historically received blocks in order to reproduce output blocks corresponding and close to the audio compressor input blocks. Many wireless audio compressors perform lossy compression in order to reduce the bandwidth significantly (e.g., up to 1:10 compression ratio).

Note also that the compressed buffer size is directly related to the compression ratio in which higher compression ratio requires an increased buffer size. A typical estimation of time delay is approximately 0.2-0.5 milliseconds. In addition, from an audio latency perspective, it is preferable to match the size of the audio compressor buffer to the packet buffer size.

Clock management 32 as shown in FIG. 2, features a free running clock with respect to base station 66. The device 64 main clock is audio clock 34, and a clock management unit 32 derives the remainder of the device 64 clocks by digitally dividing or using clock multiplication schemes such as phase locked loops (PLLs), frequency locked loops (FLLs) or delay locked loops (DLLs). Within base station 66 each unit locks on the corresponding clock. The RX PHY locks onto a frame clock (not shown) and regenerates an audio clock in block 52 for the audio expander 54 and DAC component 62 which functions to output analog audio signal 63. Since system 30 includes an arbitrary packet size (i.e. general purpose or non-deterministic) the audio compressor 40 in device 64 accepts an input audio data block from the ADC buffer 38, stores it in the input buffer 44, and compresses it into an output audio data block that is stored in the output buffer 46. Thus, audio compressor 40 which accommodates arbitrary packet sizes must maintain a large output buffer 46 that significantly contributes to delay and overall uplink latency. Similarly, in base station 66, a large expander input buffer 56 contributes to delay and overall uplink latency.

Still referring to FIG. 2, components contributing to latency in system 30 across device 64 and base station 66 are indicated in Table 1. The latency contributors can be divided into three types: (1) core latency which is a latency that cannot be minimized by faster clocking or hardware layout (e.g., buffer delay); (2) hardware dependent which is a latency that theoretically can be minimized to zero using faster clocking and/or hardware layout; and (3) medium and filters wherein the PHY layer delays some hardware dependencies but the main contributors are essential delays to achieve performance, e.g., receiver rejection.

TABLE 1
Latency contributors time tags

| Label | Description | Typical | Latency Type |
|---|---|---|---|
| Δ_{T1} | Synchronization buffer delay | Assuming an audio sampling | core latency |
| | used to track and adaptively | rate of 48 kHz. Then 2/48 ms | |
| | synchronize the audio card | for ar elaxed synchronization. | |
| | clock to the RF clock | Can work with a minimal time | |
| | | of 1/48 ms (typically 10 μs) | |
| Δ_{T2} | Compressor processing delay | ~10 μs | hardware |
| | | | dependent latency |
| Δ_{T3} | TX delay including packet | 2-3 ms (derived from overall | core latency |
| | buffering | latency requirement). Tradeoff | |
| | | between efficiency and latency. | |
| Δ_{T4} | RX delay including PHY | <50 μs | medium and filters |
| | filtering and medium | | |
| Δ_{T5} | Expander processing delay | ~10 μs | hardware |
| | | | dependent latency |
| Δ_{T6} | Compressor buffering delay | ~250 μs | core latency |
| Δ_{T7} | DAC synchronization buffer | Typically between 5-10 μs | |
| | delay | | |

As indicated, the core latency of this scheme includes the ADC input buffer 38 duration Δ_{T1} and DAC input buffer 60 duration Δ_{T7}, the packet duration and other PHY related delays (e.g., filters, etc.) Δ_{T3} the audio compressor input buffer duration Δ_{T6} which is inherently equivalent to the expander output buffer duration. Other hardware related delays include the audio compressor and expander operation durations Δ_{T2} and Δ_{T3}, respectively. Modem latency (e.g., receiver operation) is denoted by Δ_{T4}. A summary of the various latencies in system 30 of FIG. 2 is provided below.

$$CoreLatency ≅ {Δ}_{T 1} + {Δ}_{T 3} + {Δ}_{T 7} + {Δ}_{T 6} \qquad ( 1 )$$

$$HardwareDependentLatency ≅ {Δ}_{T 2} + {Δ}_{T 5} \qquad ( 2 )$$

$$ModemLatency ≅ {Δ}_{T 4} \qquad ( 3 )$$

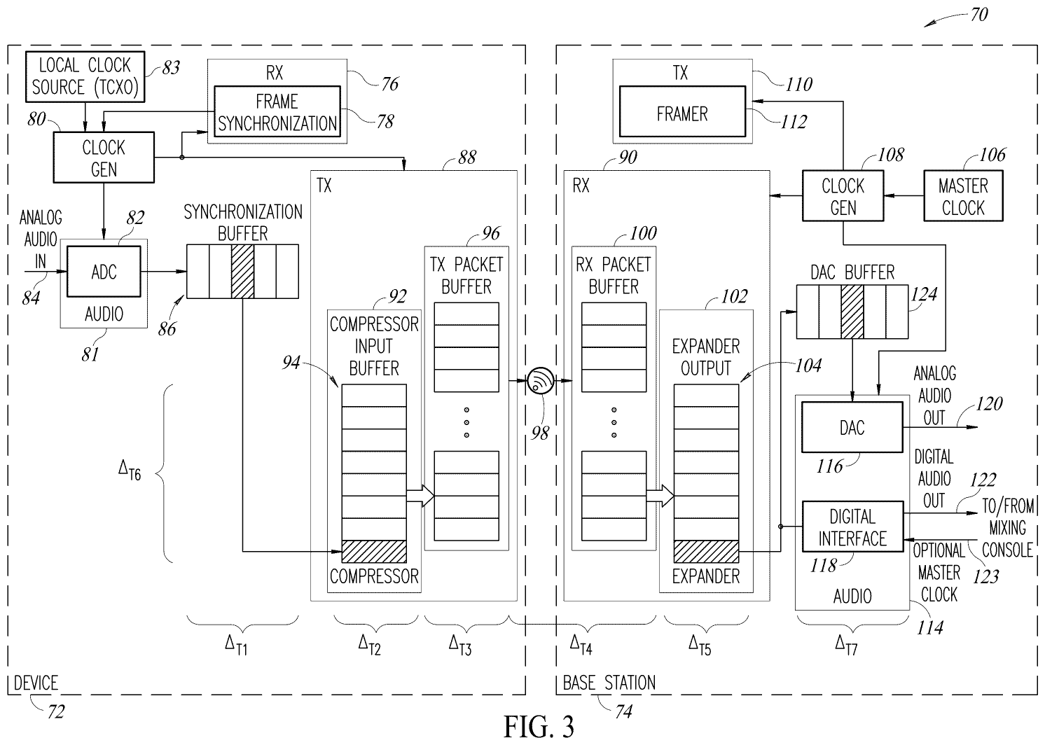

A high-level block diagram illustrating an example uplink device and base station scheme in a multi-device bidirectional communication system wireless multichannel audio system (WMAS) is shown in FIG. 3. WMAS system, generally referenced 70, comprises base station 74 in communication with one or more wireless audio devices 72 over a radio link 98. Base station 74 comprises, inter alia, a master clock 106, clock generation circuit 108, TX circuit 110 including framer 112, receiver (RX) 90, DAC buffer 124, audio block 114 including DAC 116 and digital interface circuit 118. RX circuit 90 comprises an RX packet buffer 100 coupled to audio expander 102 including audio expander output buffer 104. DAC 116 functions to generate analog audio output signal 120 while digital interface 118 generates a digital audio output signal 122 sent to mixing console 12.

Device 72 comprises audio circuit 81, local clock source 83 (e.g. TCXO), RX circuit 76, clock generator 80, synchronization buffer 86, and TX circuit 88. ADC 82 converts analog audio input 84 to digital format which is fed to synchronization buffer 86. Frame synchronization circuit 78 provides synchronization to the clock generator circuit 80. Output of synchronization buffer 86 is input to the compressor input buffer 94 in audio compressor 92. Output of audio compressor 92 is input to TX packet buffer 96.

FIG. 3 also indicates the various delays that contribute to system latency. In accordance with features of the present invention, overall latency in the system is minimized by keeping the audio system tightly locked to the RF clock. In operation, the base station (BS) 74 serves multiple devices which coexist in the overall system. Device 72 shown in system 70 functions to send audio in an uplink direction, i.e. from device 72 to BS 74. Examples of device 72 may include a wireless microphone 16, etc. as described in connection with FIG. 1 supra.

Both the device and the base station include a receiver and a transmitter, which aid in the clock recovery and locking process. BS 74 includes a master clock 106 on whose output other BS 74 clocks are locked (e.g., transmitter clock, DAC clock, receiver clock, console clock, etc.). It is appreciated that master clock 106 may be selected by the designer without loss of generality and is not critical to the invention. In device 72, receiver 76 may use a periodic over-the-air temporal signal, such as a multicast downlink packet generated and sent multi-cast to multiple devices 72 by base station 74 to generate and lock the receiver clock, transmitter clock and the ADC clock in devices 72. An example of a periodic over-the-air temporal signal is the frame synchronization signal generated by frame synchronizer circuit 78 in the RX 76.

Note that the system may either have analog outputs from a DAC 116 or a digital console interface 118, which may contain uncompressed audio signals and optionally a master clock 123 for the entire system to synchronize on. Using the digital console interface saves another Δ_{T7} delay. This delay, however, is reintroduced when the console outputs its analog output into actual speakers. If the signal is used for loopback (e.g., performer monitor signal), however, this delay is completely saved and does not get reintroduced.

Base station 74 of system 70 may have analog audio outputs 120 from DAC 116 or digital audio outputs 122 from digital console interface 118, which may contain uncompressed audio signals. Optionally, a master clock 123 may be input from mixing console 12 on which all clocks in system 70 may be synchronized.

Several key characteristics of this system allow for a significant reduction of the overall latency. They include (1) use of a master clock 106 in base station 74 from which other clocks both in base station 74 and devices 72 are locked and/or derived from; (2) the system is deterministic and contains no changes in the schedule while in ShowTime; and (3) the size of the packets used is an integer multiple of the size of the audio compressor output buffer (as well as the audio expander input buffer).

Making the size of the TX packet buffer an integer multiple of the size of the compressor output buffer enables elimination in system 70 (FIG. 3) of the audio compressor output buffer 46 (and the audio expander input buffer 56) as in system 30 (FIG. 2) as compressed packets are directly written from compressor input buffer 92, to the TX packet buffer 96 (and from the RX packet buffer 100 directly to the expander output buffer 102). The elimination of the audio compressor output buffer 46 (and the audio expander input buffer 56) significantly reduces latency of the audio uplink. Note synchronization of base station 74 with devices 72 enables audio compressor output buffer 46 and the audio expander input buffer 56 to be eliminated.

Note that the core latency of uplink system 70 includes the ADC input buffer 86 duration Δ_{T1} and DAC input buffer 124 duration Δ_{T7}, the packet duration and other PHY related delays Δ_{T3} (e.g., filters, etc.). Since, however, the packet size is an integer multiple of the compressor output buffer (and expander input buffer) size, there is no need for extra buffering. The output blocks generated by the audio compressor 92 output are simply inserted into the TX packet buffer 96 and once the last block has been written, the packet is transmitted by the transmitter 88. Conversely, on the base station 74 side, once the receiver 90 has received a complete packet, the audio expander starts operation on the first block therein. This scheme saves a significant round trip latency of typically 0.5 milliseconds-1 milliseconds (assuming a compressor buffer size of 0.25 ms-0.5 ms). Considering the sensitivity of performers and artists to latency, this is a significant and well appreciated improvement in the industry. A summary of the various latencies in system 70 of FIG. 3 is provided below.

$$CoreLatency ≅ {Δ}_{T 1} + {Δ}_{T 3} + {Δ}_{T 7} \qquad ( 4 )$$

$$HardwareDependentLatency ≅ {Δ}_{T 2} + {Δ}_{T 5} \qquad ( 5 )$$

$$ModemLatency ≅ {Δ}_{T 4} \qquad ( 6 )$$

Alternative techniques for providing audio synchronization may be utilized in different embodiments of the present invention. In some embodiments, the PHY digital clocks of devices 72 may be synchronized to the PHY clock in base station 74 by locking onto transmitted frames. To achieve maximum overall roundtrip latency goal of 6 ms the system should achieve full audio synchronization of audio devices within the WMAS. The audio codecs of devices which are normally free running clocks as well as the network PHY locked clocks (i.e. locked to frames), which may be tagged as output clocks, can be synchronized using one of the following techniques, according to different embodiments of the present invention.

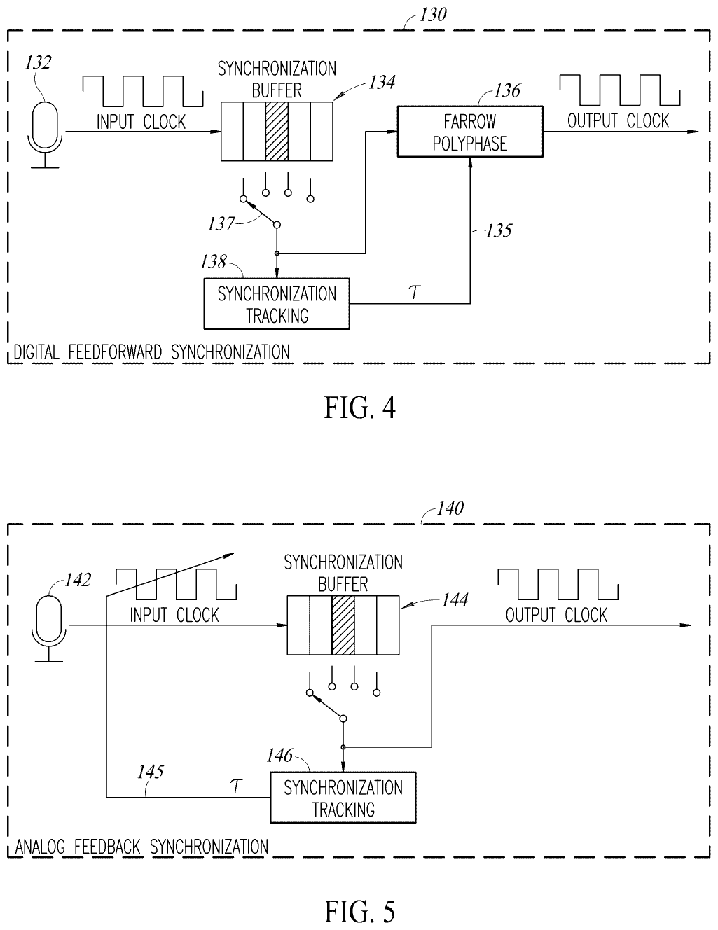

Reference is now made to FIG. 4, which describes digital feedforward synchronization where the synchronization is performed in the digital domain driven by an output clock. The circuit, generally referenced 130, comprises an audio sampling clock 132, synchronization buffer 134, synchronization tracking block 138, and Farrow polyphase filter 136.

In operation, the Farrow polyphase circuit 136 can interpolate the signal at any fractional point of timing, signal 135 with considerable accuracy and is commanded by synchronization tracking circuit 138. Since the input and output clocks are independently free running, the synchronization elastic buffer 134 may contain a variable delay, whose length changes (i.e. increases or decreases) based on clock drift between the two clocks. Synchronization and tracking circuit 138 tracks this buffer length and assumes the correct number of samples per frame. In order to compensate for the clock drift, circuit 138 changes the sampling point t 135 given to the Farrow polyphase filter 136 and changes (i.e. via a skip/add process) synchronization buffer switch position 137.

A block diagram illustrating a second example of audio synchronization using analog feedback synchronization is shown in FIG. 5. The second technique uses analog feedback synchronization where the synchronization tracking circuitry changes the audio sampling rate (i.e. the input clock) by a feedback signal. The circuit, generally referenced 140, comprises an audio sampling clock 142, synchronization buffer 144, and synchronization tracking block 146.

In operation, the synchronization tracking 146 generates a feedback signal 145 that controls the audio sampling rate. The output audio clock is derived from the output of the synchronization buffer. Since the input and output clocks are independently free running the synchronization elastic buffer 144 may contain a variable delay, whose length changes (i.e. increases or decreases) based on the clock drift between the two clocks. Synchronization and tracking circuit 146 tracks this buffer length and assumes the correct number of samples per frame. It uses variable input clock 142 in order to compensate in feedback form for the drifts and make sure that synchronization buffer 144 does not over or underflow.

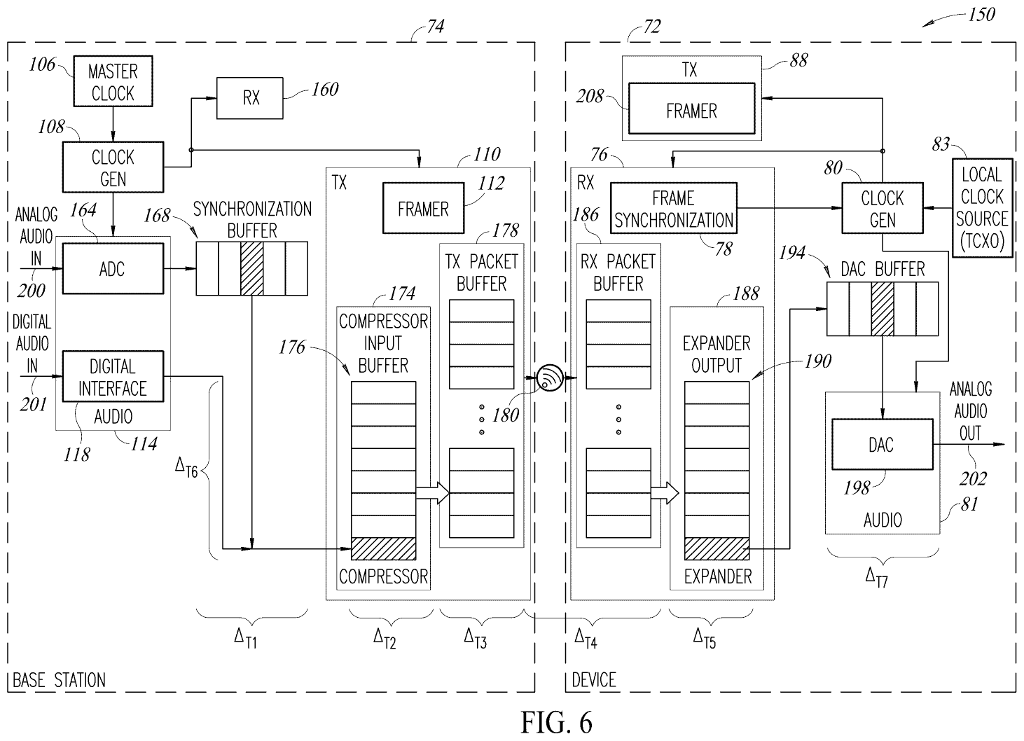

A high-level block diagram illustrating an example downlink device and base station in a multi-device bidirectional communication system is shown in FIG. 6. The system, generally referenced 150, comprises base station 74 in communication with devices 72 over a radio link 180 that make up the WMAS. Base station 74 functions to serve multiple devices 72 and an example device 72 is shown on the right. Device 72 receives audio in the downlink direction (i.e. from base station 74 to device 72). An example of device 72 is an in-ear monitor (IEM), whether mono or stereo.

Base station 74 comprises, inter alia, a master clock 106, clock generation circuit 108, TX circuit 110, RX circuit 160, audio circuit block 114, and synchronization buffer 168. The audio circuit 114 comprises ADC 164 and digital interface circuit 118. The TX circuit 110 comprises framer 112, audio compressor 174 including input buffer 176 and TX packet buffer 178.

ADC 164 converts analog audio input 200 to digital format which is fed to the synchronization buffer 168. Framer circuit 112 provides synchronization to the devices on the network. The output of the synchronization buffer 168 is input to the compressor input buffer 176 in the audio compressor 174. The output of the audio compressor 174 is input to the TX packet buffer 178.

Device 72 may comprise temperature-controlled crystal oscillator (TCXO) 83, clock generator circuit 80, RX circuit 76, DAC buffer 194, TX circuit 88 including framer 208, and audio circuit 81. RX circuit 76 comprises an RX packet buffer 186 coupled to audio expander 188 including audio expander output buffer 190. A digital-to-analog converter DAC 198, inputs digital data from DAC buffer 194 and functions to generate analog audio output signal 202. In receiver RX 76, a frame synchronization circuit 78 derives clock timing from the inbound frames which is used by clock generator circuit 80 to synchronize all clocks in device 72 to base station 74.

The various delays (i.e., Δ_{T1} to Δ_{T7} that contribute to the overall latency are indicated in FIG. 6. By keeping the audio system tightly locked to the RF clock, the system minimizes the overall latency.

Both the device and the base station include a receiver and a transmitter, which aid in the clock recovery and locking process. The BS includes a master clock 106 on whose output the rest of base station 74 clocks are locked (e.g., transmitter clock, DAC clock, receiver clock, console clock, etc.).

On device 72 side, receiver 76 may use a periodic over-the-air temporal signal generated and sent by base station 74 to generate and lock the receiver clock, transmitter clock and the ADC clock. An example of a periodic over-the-air temporal signal is the frame synchronization signals generated by frame synchronizer circuit 78, transmitted as downlink packets and received in the RX 76.

Note that system 150 may either have analog audio input 200 to an ADC 164 or digital audio input 201 to a digital console interface 118, which may contain uncompressed audio signals and optionally a master clock for the entire system to synchronize on.

Several key characteristics of this system allows for a significant reduction of the overall downlink latency. They include (1) use of a single master clock from which all other clocks are locked and derived from; (2) the system is deterministic and contains no changes in the schedule while in ShowTime; and (3) the size of the packets used is an integer multiple of the size of the audio compressor output buffer as well as the audio expander input buffer.

Note that the core latency of downlink system 150 includes the ADC input buffer 168 duration Δ_{T1} and DAC input buffer 194 duration Δ_{T7}, the packet duration and other PHY related delays 473 (e.g., filters, etc.). Since, however, the packet size is an integer multiple of the compressor output buffer 178 (and expander input buffer 186) size, there is no need for extra buffering. The output blocks generated by audio compressor 174 are simply inserted into TX packet buffer 178 and once the last block has been written, the packet is transmitted by transmitter 110. Conversely, on device 72 side, once receiver 76 has received the complete packet, the audio expander 188 starts its operation on the first block therein. This scheme saves a significant round trip latency of typically 0.5-1.0 ms (assuming a compressor buffer size of 0.25-0.5 ms). A summary of the various latencies in system 150 of FIG. 6 is provided below.

$$CoreLatency ≅ {Δ}_{T 1} + {Δ}_{T 3} + {Δ}_{T 7} \qquad ( 7 )$$

$$HardwareDependentLatency ≅ {Δ}_{T 2} + {Δ}_{T 5} \qquad ( 8 )$$

$$ModemLatency ≅ {Δ}_{T 4} \qquad ( 9 )$$

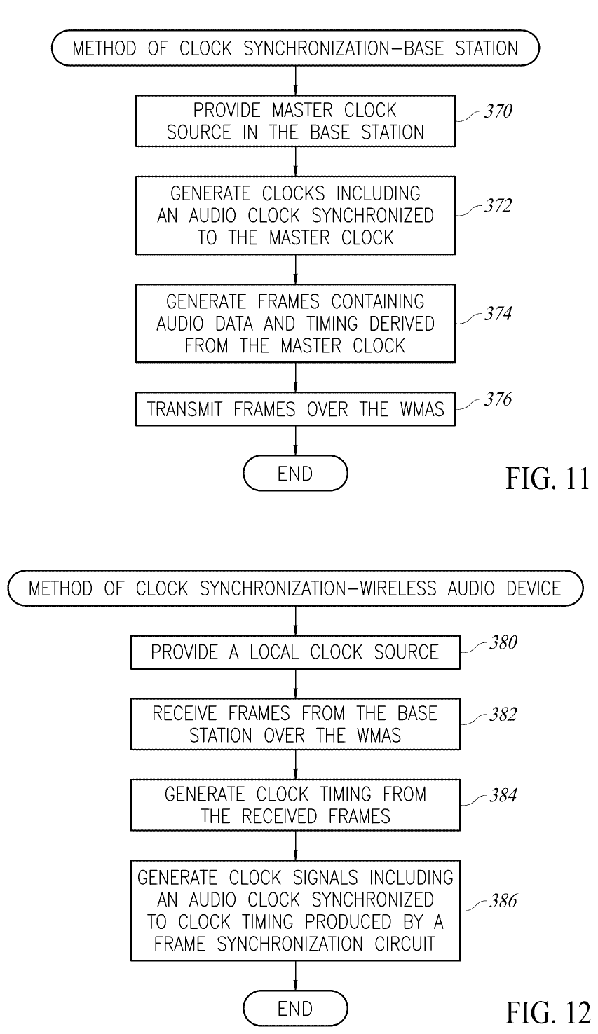

A flow diagram illustrating an example; method of clock synchronization for use in the base station is shown in FIG. 11. Clock synchronization in the system is derived from the master clock source in the base station (step 370). A clock generator circuit uses the master clock (or one provided externally) to generate the various clocks used in the system including an audio clock all of which are synchronized to the master clock (step 372). The base station generates frames containing audio data and timing derived from the master clock (step 374) which are then transmitted over the WMAS to the wireless devices (step 376).

A flow diagram illustrating an example method of clock synchronization for use in the wireless audio device is shown in FIG. 12. A clock source is provided in each wireless audio device (step 380). Frames sent from the base station are received over the WMAS at each device (step 382). Clock timing for the device is extracted from the received frames using the techniques shown in FIGS. 4 and 5 (step 384). The various clock signals required are then generated including an audio clock synchronized to clock timing produced by the frame synchronization circuit (step 386).

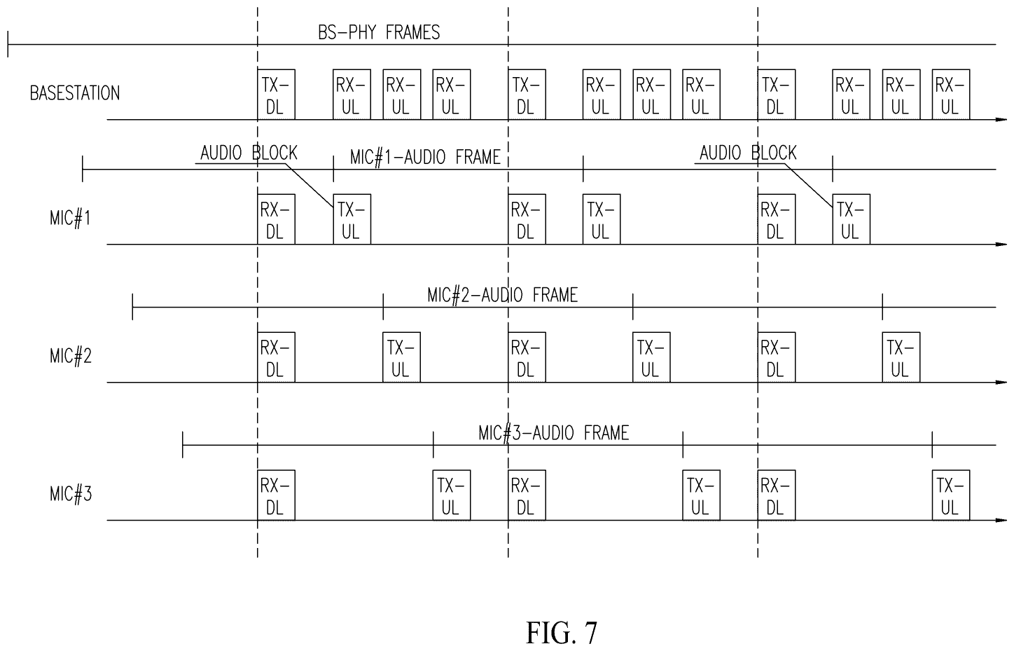

A diagram illustrating timing for an example WMAS system in accordance with an embodiment of the present invention is shown in FIG. 7. The network in this example embodiment comprises a base station and three microphones. The base station determines the PHY frames. Those frames are recovered using the frame synchronizers in each microphone and are therefore substantially common to all the members in the network. Each frame begins with a downlink transmission from the base station to the devices used by the frame synchronizers in the microphones to lock onto the PHY frame structure. Following the downlink packets, each microphone transmits its uplink packet in designated and predetermined time slots.

Each microphone runs its own audio block consisting of the time between start of transmission of the respective UL packet and the subsequent UL packet. The audio frame duration is identical to the PHY frame duration, but time shifted.

During each audio block, each microphone processes the samples of the captured audio, compresses them and stores them in the TX buffer. To minimize latency, the audio block completes its cycle immediately before the designated TX slot. Therefore, the audio blocks for the various microphones are time shifted with respect to each other.

Similarly, in the case of in-ear monitors (IEMs) the base station generates multiple audio frames that match the downlink transmissions for each device.

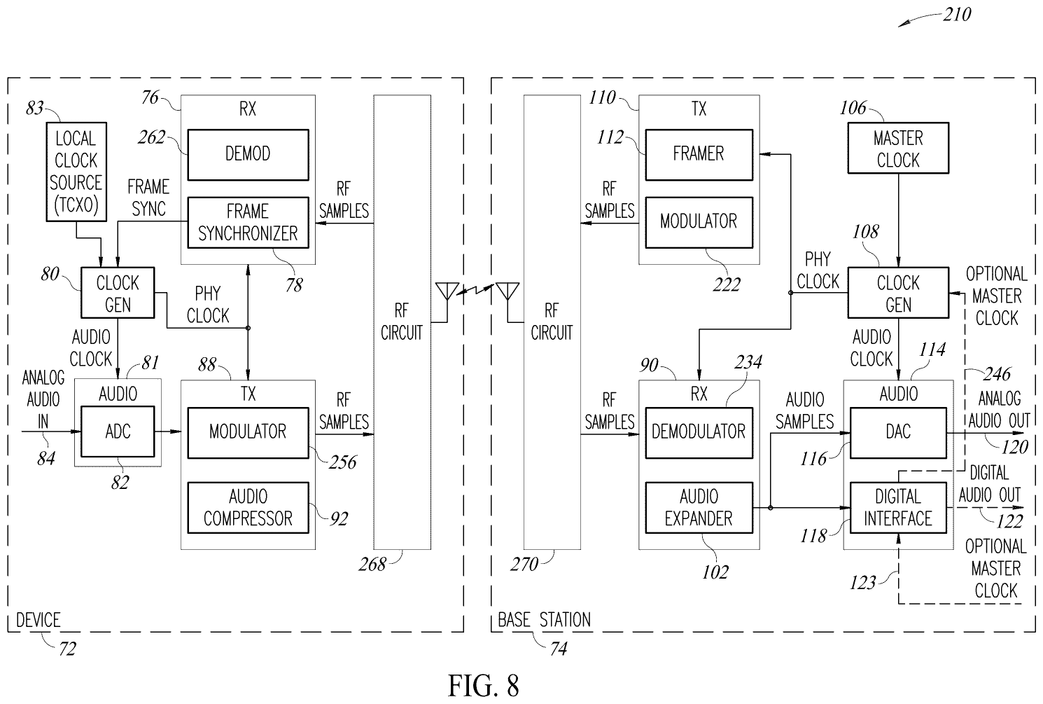

A high level block diagram illustrating an example uplink buffering and clocking scheme is shown in FIG. 8. The system, generally referenced 210, comprises base station 74 in communication with one or more devices 72 over a radio link that make up the WMAS. Base station 74 comprises, inter alia, a master clock 106, clock generation circuit 108, RF circuit 270, TX circuit 110, RX circuit 90, and audio circuit block 114. Audio circuit 114 comprises DAC 116 that generates analog audio out 120 and digital interface circuit 118 that receives an optional external master clock 123 and generates an optional output master clock 246 to the clock generator circuit 108 and may generate digital audio out 122. TX circuit 110 comprises framer 112 and modulator 222 to generate RF samples output to RF circuit 270 for transmission. RX circuit 90 comprises demodulator 234 and audio expander 102 and receives RF samples from RF circuit 270 to generate audio samples output to DAC 116.

Device 72 comprises RF circuit 268, TX circuit 88, RX circuit 76, audio circuit block 81, and clock generation circuit 80. Audio circuit 81 comprises ADC 82. TX circuit 88 comprises modulator 256 and audio compressor 92. RX circuit 76 comprises demodulator 262 and frame synchronizer 78.

ADC 82 functions to convert analog audio-in 84 to digital samples which are input to the TX circuit 88. RF samples output of TX circuit 88 are input to RF circuit 268 for transmission. On the receive side, RF circuit 268 outputs received RF samples to RX circuit 76 where they are demodulated. Frame synchronizer 78 generates timing from the received frames to synchronize its clocks with base station master clock 106. The derived timing is input to the clock generator circuit 80 and used to generate the various clocks in the device including the audio clock.

The system shown in FIG. 8 highlights the clocking scheme for base station 74 and uplink device 72 in accordance with the present invention. Master clock 106 in base station 74 is used to derive and synchronize digital clocks within the entire system 210. This clock may comprise a local oscillator (e.g., TCXO, etc.) in base station 74 or optionally can be supplied from the digital interface 118 coupled to a mixing console.

With reference to FIG. 8, the clock generator circuit 108 generates clocks including for example TX, RX, and audio clocks. TX circuit 110 includes a framer 112 and a modulator 222, while the RX circuit 90 includes a demodulator 234 and an audio expander 102. Audio expander 102 outputs digital samples after the expander process to either DAC 116 in audio system 114 or a digital interface 118. Base station 74 also includes an RF circuit 270 which converts RF samples from TX 110 into RF waves and receives RF waves to output RF samples to RX 90.

Uplink device 72 (e.g., wireless microphone, IEM, etc.), shown on the left-hand side includes the receiver RX 76, transmitter TX 88, audio sub system 81 and a clock generator module 80. It is noted that in one embodiment uplink devices have two-way communications for management and synchronization purposes. Clock gen module 80 functions to generate clocks (e.g., PHY clock, audio clock, etc.) for the RX 76, TX 88, RF 268 circuits, and audio systems by locking and deriving digital clocks from the frame synchronization in the RX module 76. RX 76 includes a demodulator 262 and a frame synchronizer 78, which locks onto the frame rate and phase using techniques such as packet detection, correlators, PLLs, DLLs, FLLs, etc. TX 88 includes a modulator 256, and an audio compressor 92 and the audio block 81 contains an ADC 82 converting the input analog signals into digital audio samples. Furthermore, device 72 contains an RF subsystem 268 which is operative to convert RF samples from TX 88 into RF waves and receives RF waves to output RF samples to RX 76.

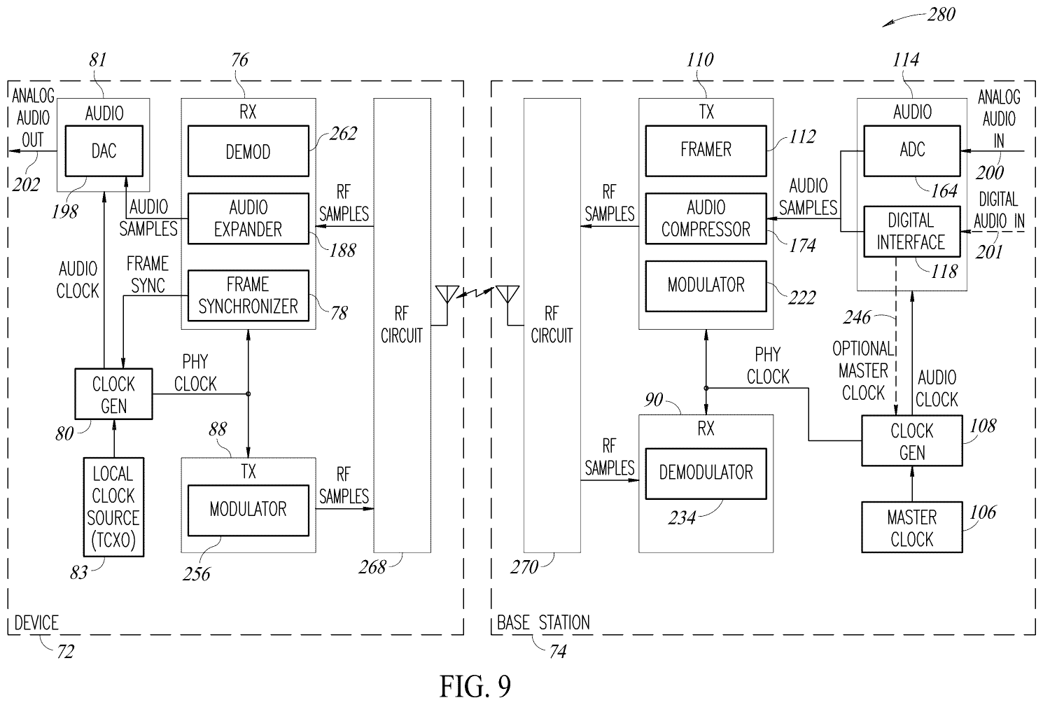

A high-level block diagram illustrating an example downlink buffering and clocking scheme is shown in FIG. 9. The system, generally referenced 280, comprises base station 74 in communication with one or more devices 72 over a radio link that make up the WMAS. Base station 74 comprises, inter alia, a master clock 106, clock generation circuit 108, RF circuit 270, TX circuit 110, RX circuit 90, and audio circuit block 114. Audio circuit 114 comprises ADC 164 that converts analog audio-in 200 to digital audio samples; and a digital interface 118. Digital interface circuit 118 receives an optional digital audio-in signal 201 from a mixing console and generates output audio samples and an optional master clock 246 to the clock generator circuit 108. TX circuit 110 comprises framer 112, audio compressor 174, and modulator 222 to receive the audio samples and generate RF samples output to RF circuit 270 for transmission. RX circuit 90 comprises demodulator 234 that receives RF samples from the RF circuit 270 to generate audio samples output to the DAC (not shown).

Device 72 comprises RF circuit 268, TX circuit 88, RX circuit 76, audio circuit block 81, local clock source (e.g. TCXO) 83 and clock generation circuit 80. Audio circuit 81 comprises DAC 198. TX circuit 88 comprises modulator 256 and audio compressor (not shown). RX circuit comprises demodulator 262, audio expander 188, and frame synchronizer 78.

RF samples output of TX circuit 88 are input to RF circuit 268 for transmission. On the receive side, RF circuit 268 outputs received RF samples to RX circuit 76 where they are demodulated. Frame synchronizer 78 generates timing (frame sync signal) from the received frames to synchronize its clocks with base station master clock 106,246. The derived timing is input to the clock generation circuit 80 and used to generate the various clocks in device 72 including the audio clock.

The system shown in FIG. 9 highlights a clocking scheme for the base station and a downlink device (e.g., IEM, etc.) in accordance with the present invention. The master clock 106,246 in base station 74 is used to derive and synchronize digital clocks within the entire system. The master clock may comprise a local oscillator (e.g., TCXO, etc.) in base station 74 or optionally may be generated by digital interface 118 from an input digital audio signal 201 from a mixing console.

In base station 74, clock generator circuit 108 generates clocks including for example TX, RX, RF, and audio clocks. TX circuit 110 includes a framer 112, audio compressor 174, and a modulator 222, while the RX circuit 90 includes a demodulator 234. Analog audio-in 200 is converted by the ADC to digital audio samples. Base station 74 also includes an RF unit 270 which converts RF samples from TX 110 into RF waves and receives RF waves to output RF samples to RX 90.

Downlink device 72 (e.g., IEM, etc.), shown on the left-hand side includes the RF circuit 268, receiver RX 76, transmitter TX 88, an audio sub-system 81 and a clock generator module 80. It is noted that in one embodiment downlink devices have two-way communications for management and synchronization purposes. Clock generator module 80 functions to generate clocks (e.g., PHY clock, audio clock, etc.) for the RX, TX, RF circuit, and audio systems by locking and deriving digital clocks from frame synchronization module 78 in RX module 76. RX module 76 includes demodulator 262 and frame synchronizer 78, which locks onto the frame rate and phase using techniques such as packet detection, correlators, PLLs, DLLs, FLLs, etc.

TX 88 includes a modulator 256. Audio circuit 81 includes DAC 198 that converts the audio samples output of audio expander 188 to analog audio-out 202. Furthermore, device 72 includes RF subsystem 268 which is operative to convert RF samples from TX 88 into RF waves and receives RF waves to output RF samples to the RX 76.

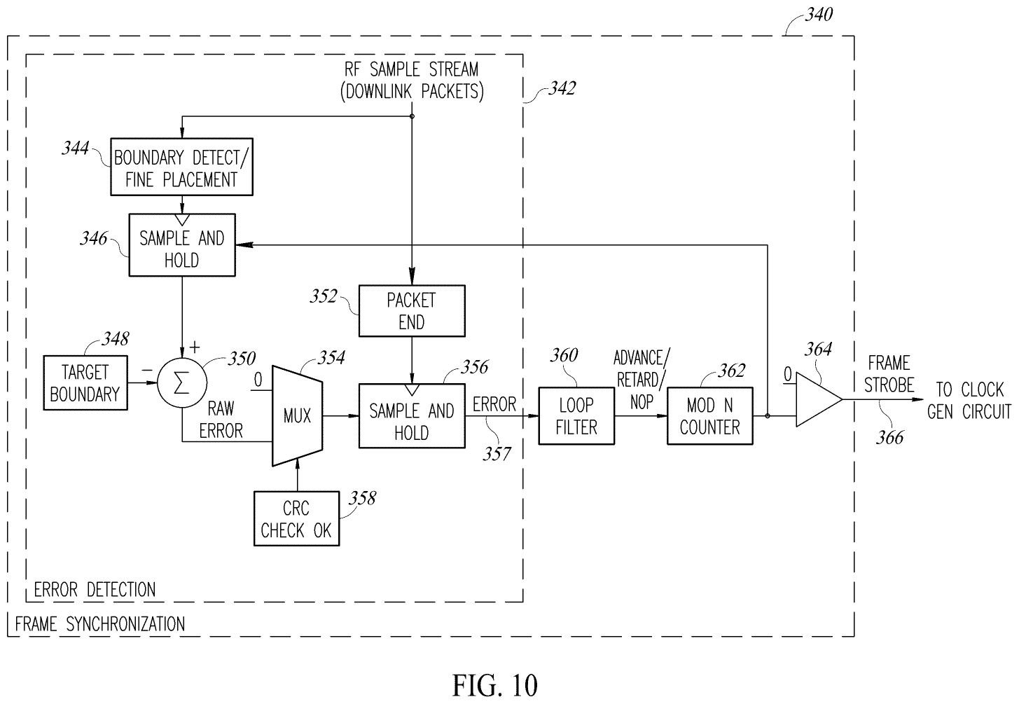

A high-level block diagram illustrating an example frame synchronizer is shown in FIG. 10. Note that the description provided herein assumes that there is at least one downlink packet in every frame. Without loss of generality, it is assumed that the first packet within a frame is a downlink packet.

The example frame synchronizer circuit, generally referenced 340, essentially comprises a phase locked loop (PLL) circuit that includes an error detector circuit 342, loop filter 360, a digitally controlled oscillator (DCO) implemented using a mod N counter 362, and comparator 364. The error detector 342 comprises boundary detect/fine placement circuit 344, sample and hold circuit 346, error signal subtractor 350, mux 354, sample and hold circuit 356, and packet end detect 352.

In operation, error detector 342 uses the PHY boundary detector and fine placement circuit 344, which functions to detect a precise position within received packets which can vary based on the type of modulation used. The strobe output of this block functions to provide timing for the sample and hold block 346, which samples the output of the DCO (i.e. the output of the mod N counter 362) and therefore holds the counter value at which the boundary detect/fine placement was obtained.

The target boundary value 348 which is expressed as a number indicating the number of samples from the beginning of a packet to the ideal boundary detect point. This number is subtracted from the output of the sample and hold 346 via subtractor 350 to yield the raw error expressed as a number of samples. This raw error is input to a mux 354, whose output is determined by the ‘CRC check OK’ signal 358 received from the PHY at the end of the packet. If the CRC check is valid, then the raw error is output from the mux, otherwise a zero is injected (i.e. no correction is input into the loop filter). The mux output is input to another sample and hold 356, which is triggered at the end of the packet 352 since the CRC OK signal is valid only at the end of the packet.

The error signal 357 is input to the loop filter 360, which can be realized by a bang bang controller, 1^{st} order loop, 2^{nd} order loop, PID controller, etc. The loop filter outputs a positive number (i.e. advance or increment the counter), negative number (i.e. retard or decrement the counter), or zero (i.e. NOP or no operation). Thus, the mod N counter is advanced, retarded, or unchanged depending on the error output. The DCO modulo N counter 362 increments by one each clock and is free running using the system local oscillator. A frame strobe is generated every time the counter resets to zero. The output of the DCO is compared with zero and the output of the comparator 364 generates the frame strobe to the rest of the system which is then used to derive the various clocks in the device, e.g., audio clock, RF clock, PHY clocks, etc.

Those skilled in the art will recognize that the boundaries between logic and circuit blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention is not limited to the limited number of embodiments described herein. The embodiments were chosen and described in order to best explain the principles of the invention and the practical application, and to enable others of ordinary skill in the art to understand the invention for various embodiments with various modifications as are suited to the particular use contemplated.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

| Abbreviations | |
|---|---|
| AAC | Advanced Audio Coding (AAC) is an audio coding standard for lossy digital |
| | audio compression. |
| ADC | analog-to-digital converter |
| BS | base station |
| CRC | A cyclic redundancy check (CRC) is an error-detecting code commonly used in |
| | digital networks and storage devices to detect accidental changes to digital data |
| DAC | digital-to-analog converter |
| DCO | digitally controlled oscillator |
| DTV | Digital television |
| DL | downlink |
| DLL | Delay locked loop |
| FDM | Frequency division multiplexing |
| FLL | Frequency locked loop |
| GFSK | Gaussian Frequency Shift Keying |
| IEM | in-ear monitor |
| IMU | inertial measurement unit |
| ISM | The ISM radio bands are portions of the radio spectrum reserved internationally |
| | for industrial, scientific, and medical (ISM) purposes, excluding applications in |
| | telecommunications. |
| LDAC | LDAC is a proprietary audio coding technology developed by Sony, which |
| | allows streaming high-resolution audio over Bluetooth connections |
| MP3 | MP3 is a coding format for digital audio |
| MHz, GHz | MegaHertz, gigaHertz |
| ms | milliseconds |
| OFDM | Orthogonal frequency-division multiplexing (OFDM) is a multi-carrier |
| | modulation system where data is transmitted as a combination of |
| | orthogonal narrowband signals known as subcarriers. |
| OSI | Open Systems Interconnection model (OSI model) is a conceptual model which |
| | provides a common basis for the coordination of [ISO] standards development |
| | for the purpose of systems interconnection. In the OSI reference model, |
| | communications between a computing system are split into seven different |
| | abstraction layers: Physical, Data Link, Network, Transport, Session, |
| | Presentation, and Application |
| OTA | over the air |
| PER | packet error rate |
| PHY | ″Physical layer″, an electronic circuit, usually implemented as an integrated |
| | circuit, required to implement physical layer functions of the OSI model |
| PLL | phase locked loop |
| RX | receiver |
| TDM | Time-division multiplexing |
| TCXO | Temperature-controlled crystal oscillator |
| TVB | |
| TX | transmitter |
| UHF | Ultra high frequency (UHF) is the ITU designation for radio frequencies in the |
| | range between 300 megahertz (MHz) and 3 gigahertz (GHz), also known as the |
| | decimeter band as the wavelengths range from one meter to one tenth of a meter |
| | (one decimeter). |
| UL | uplink |
| VHF | Very high frequency-range of radio frequency electromagnetic waves (radio |
| | waves) from 30 to 300 megahertz (MHz), with corresponding wavelengths of |
| | ten meters to one meter. |
| Wi-fi | Wi-Fi 6 (2.4 GHz and 5 GHZ)[6] and Wi-Fi 6E (6 GHZ), an IEEE standard for |
| 802.11ax | wireless local-area networks (WLANs) and successor of 802.11ac |
| WMAS | Wireless Multichannel Audio System |

1. A wireless multi-channel audio system (WMAS), comprising a base station and a wireless audio device:
the base station including:
a master clock source;
a framer operative to generate base station frames containing audio data and related audio clock timing derived from said master clock source;
a transmitter operative to transmit said frames over said WMAS;
the wireless audio device including:
a receiver operative to receive frames from said base station over said WMAS;
a frame synchronization circuit operative to generate audio data and a related timing signal from said received frames; and
a clock generator circuit operative to input a local clock signal generated by said frame synchronization circuit to generate therefrom a plurality of clocks, including an audio clock, derived from the timing signal to synchronize the wireless audio device to base station frames and to enable thereby communications according to a previously determined schedule with the base station, wherein during operation: (i) clocks in said WMAS synchronized to and derived from said master clock source in said base station and (ii) the communications with the previously determined schedule, enable a reduction of latency to less than or equal to four nanoseconds, wherein the latency is a time interval between reception of an audio event at a microphone and outputting an audio signal from the base station corresponding to the audio event.

2. The system according to claim 1, wherein in the wireless audio device, the frame synchronization circuit is operative to generate audio data and related timing using detected PHY frame boundary timing via signal correlation associated with the received frames.

3. The system according to claim 1, the wireless audio device further including:
an analogue-to-digital converter (ADC) for converting an input audio signal to digital domain utilizing the audio clock;
a synchronization buffer operative to receive digital output of said ADC;
a compressor and related compressor buffer operative to receive output of said synchronization buffer;
a first RF modem including a transmitter and related TX packet buffer operative to receive output of said compressor;
wherein compressed packets are directly written from the compressor buffer to a TX packet buffer for transmission to the base station.

4. The system according to claim 3, wherein the TX packet buffer size is an integral number of compressor buffer size.

5. The system according to claim 1, wherein said wireless audio device is included in a microphone system.

6. The system according to claim 1, the wireless audio device further including:
an expander and related expander buffer;
an RF modem and related RX packet buffer operative, to output compressed packets directly written from the RX packet buffer to the expander buffer; and
a digital-to-analog DAC converter operative to input audio samples from the expander buffer to output an analog audio signal, utilizing the audio clock.

7. The system according to claim 6, wherein the RX packet buffer size is an integral number of the expander buffer size.

8. The system according to claim 1, wherein said master clock source includes a local oscillator in said base station or a clock signal from an audio mixing console to a digital interface in said base station.

9. The system according to claim 1, wherein the previously determined schedule includes uplink and the downlink communications over a same channel.

10. (canceled)

11. (canceled)

12. The system according to claim 1, further comprising, in the wireless audio device, a synchronization circuit operative to provide digital feedforward synchronization or analog feedback synchronization of an audio clock to frame synchronization clock timing.

13. The system according to claim 1, wherein clocks include further at least one of: an analog-to digital converter (ADC) clock, a digital-to-analog converter (DAC) clock, a transmitter (TX) clock, a receiver (RX) clock, and a radio frequency (RF) clock.

14. The system according to claim 1, wherein the frame synchronization circuit includes at least one of: a packet detector circuit, a correlator circuit, a phase locked loop (PLL) circuit, a delay-locked loop (DLL) circuit, and frequency locked loop (FLL) circuit.

15. A method of clock synchronization for use in a multichannel audio system (WMAS) including a base station and a wireless audio device, the method comprising, in the base station:
providing a master clock source;
generating a first plurality of clocks including a first audio clock synchronized to said master clock source;
generating frames containing audio data and timing derived from said master clock;
transmitting said frames over said WMAS;
in the wireless audio device:
receiving frames from said at least one base station over said WMAS;
generating clock timing from said received frames;
generating a second plurality of clocks including a second audio clock synchronized to said clock timing;
synchronizing said first clocks in the base station and said second audio clock in said wireless audio device to said master clock source, thereby enabling communications according to a previously determined schedule with the base station, wherein said synchronizing and said communications with said previously determined schedule enable a reduction of latency, to less than or equal to four nanoseconds, wherein the latency is a time interval between reception of an audio event at a microphone and outputting an audio signal from the base station corresponding to the audio event.

16. The method according to claim 15, further comprising in the wireless audio device:
generating audio data and the related clock timing using detected PHY frame boundary timing via signal correlation associated with the received frames.

17. The method according to claim 15, wherein the previously determined schedule includes uplink and the downlink communications over a same frequency channel.

18. (canceled)

19. The method according to claim 15, further comprising synchronizing, in the wireless audio device, an audio clock to frame synchronization clock timing using digital feedforward synchronization or analog feedback synchronization.

20. (canceled)

21. The method according to claim 15, wherein generating clock timing from said received frames is performed using a packet detector circuit, correlator circuit, phase locked loop (PLL) circuit, delay locked loop (DLL) circuit, and/or frequency locked loop (FLL) circuit.

22. A wireless audio device included in a microphone system or in an in-ear monitor, the wireless audio device for use in a multichannel audio system (WMAS), the wireless audio device comprising:
a receiver operative to receive frames over said WMAS, said frames containing timing derived from a master clock source in said WMAS;
a frame synchronization circuit operative to extract clock timing from said received frames; and
a clock generator circuit operative to generate a plurality of clocks synchronized to said clock timing generated by said frame synchronization circuit to synchronize the wireless audio device to said received frames and to enable thereby communications according to a previously determined schedule, wherein: during operation: (i) the clocks synchronized to and derived from said master clock source, and (ii) the communications according to the previously determined schedule, enable a reduction of latency, to less than or equal to four nanoseconds, wherein the latency is a time interval between reception of an audio event at a microphone and outputting an audio signal from the base station corresponding to the audio event.

23. The wireless audio device of claim 22, wherein the frame synchronization circuit is operative to generate audio data and related timing using detected PHY frame boundary timing via signal correlation associated with the received frames.

24. The wireless audio device of claim 22, wherein the previously determined schedule includes uplink and the downlink communications over a same frequency channel.

25. (canceled)
